(19) United States
(12) Patent Application Publication
(10) Pub. No.: US 2004/0098276 A1
(43) Pub. Date: May 20, 2004

(54) Method and system for passenger and baggage security control in a tansportation system

(75) Inventors: Richard N. Blazey, Penfield, NY (US); Dale F. McIntyre, Honeoye Falls, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/295,532

(22) Filed: Nov. 15, 2002

(51) Int. Cl. G06F 17/60

(52) U.S. Cl. 705/1

(57) ABSTRACT

A method for passenger and baggage security control in a transportation system is provided, comprising the steps of: acquiring a digital image of a passenger; providing a passenger boarding pass, a baggage tag, and a baggage claim check, each item bearing machine and human readable trip information, image information related to the passenger's digital image, and hidden authenticating information, the baggage tag also having an RFID device bearing said trip information; electronically scanning the machine readable information on the baggage tag when the baggage is loaded for the trip and creating and storing a list of all loaded baggage for the trip; authenticating the boarding pass by electronic scanning to detect the hidden authentication information when the boarding pass is presented; accessing the passenger digital image information and comparing the passenger's appearance to the image of the passenger; accepting the passenger for boarding when the authentication data is present and the passenger's appearance matches the passenger image; and creating and storing a list of all boarded passengers.

### FIELD OF THE INVENTION

This invention is in the field of systems and methods for the security control of passengers and baggage in a transportation system. More specifically, the invention is in the field of security control systems with authentication of passenger boarding documents and positive matching of baggage to passengers.

### BACKGROUND OF THE INVENTION

The security of transportation systems is a problem of growing concern. A key element in providing security for these systems is to be able to prevent the boarding of a plane, train, bus, or other means of public or private transport, by unauthorized persons who may not have a valid ticket or may be traveling under a false identity. Another important security problem is to prevent baggage from being loaded which is not associated with any boarded passenger. Recent changes in the law require “positive bag matching” to be carried out by airlines prior to clearance for departure.

Current security procedures require passengers to present a boarding pass, issued at passenger check-in, at the boarding gate in order to be cleared for boarding. Since there is no positive means of associating a particular boarding pass with a particular person, a substitution could be made. An unauthorized passenger using the boarding pass of a passenger who had actually been through check-in might be able to board in his or her place. Great Britain Patent No. 2,338,620 to Seki and Aikawa discloses a boarding pass with an image of the passenger whose boarding pass it is printed on it, but the pass has no security feature to authenticate the pass itself and prevent it from being copied, counterfeited, or altered.

Positive matching of baggage with passengers can be accomplished today by requiring each piece of baggage of a passenger to carry a baggage tag, provided at passenger check-in, to carry bar-coded information relating to the particular scheduled trip or flight the passenger is boarding. All baggage tags are scanned when loaded, and a list of loaded baggage can later be compared to a manifest of all passengers who actually boarded. However, if an unmatched bag is found in this way, there is currently no easy way to find the unmatched bag quickly and unload it. Current methods of retrieving such a bag are slow and could cause a costly, and potentially disastrous, delay in retrieving the unmatched bag. European Patent Application No. 0 851 377 A1, to MacLellan, et al., discloses the use of radio frequency identification (RFID) tags in a baggage handling system. In MacLellan, et al., an RFID tag attached to piece of baggage stores information specific to the particular bag to which it is attached and can be used to track bags in a baggage handling system. The RFID tracking system disclosed in MacClellan et al. does not, however, address the problem of locating precisely where one individual bag is located in a crowded baggage holding area along with many others bags.

Yet another security problem is that currently there is no feature of baggage tags to prevent them from being counterfeited. Hence, it is possible for a bag, not actually checked by a passenger but bearing a counterfeit baggage tag and therefore seemingly associated with a passenger, to be loaded without being detected.

### SUMMARY OF THE INVENTION

In answer to these and other problems of the prior art, in accordance with one aspect of the present invention, there is provided a method for passenger and baggage security control in a transportation system, comprising the steps of: acquiring a digital image of a passenger; providing a passenger boarding pass, a baggage tag, and a baggage claim check, each item bearing machine and human readable trip information, image information related to the passenger's digital image, and hidden authenticating information, the baggage tag also having an RFID device bearing said trip information; electronically scanning the machine readable information on the baggage tag when the baggage is loaded for the trip and creating and storing a list of all loaded baggage for the trip; authenticating the boarding pass by electronic scanning to detect the hidden authentication information when the boarding pass is presented; accessing the passenger digital image information and comparing the passenger's appearance to the image of the passenger; accepting the passenger for boarding when the authentication data is present and the passenger's appearance matches the passenger image; and creating and storing a list of all boarded passengers.

In accordance with another aspect of the present invention, there is provided a label system for passenger and baggage control in a transportation system, comprising: a boarding pass part; a baggage tag part and baggage claim check part for each piece of the baggage of the passenger, the baggage tag part also having an RFID device bearing the trip information; information related to a digital image of the passenger incorporated on each the parts of the label; human and machine readable trip information included on each the parts of the label; hidden authenticating information incorporated in each the parts of the label.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a schematic block diagram of a passenger and baggage security control system made in accordance with the present invention;

FIG. 2a depicts a passenger boarding pass in accordance with the present invention;

FIG. 2b illustrates a two-part baggage tag and claim check document made in accordance with the present invention;

FIG. 3 provides an exploded view of the detailed construction of a portion of a baggage tag made in accordance with the present invention;

FIG. 4 is a flow chart of the steps in the operation of the present invention at a check-in station;

FIG. 5 is a flow chart of the steps in the operation of the present invention at a boarding gate;

FIG. 6 is a flow chart of the steps in the operation of the present invention at a baggage loading area; and

FIG. 7 is a flow chart of the steps in the operation of the present invention at a baggage claim area.

### DETAILED DESCRIPTION OF THE INVENTION

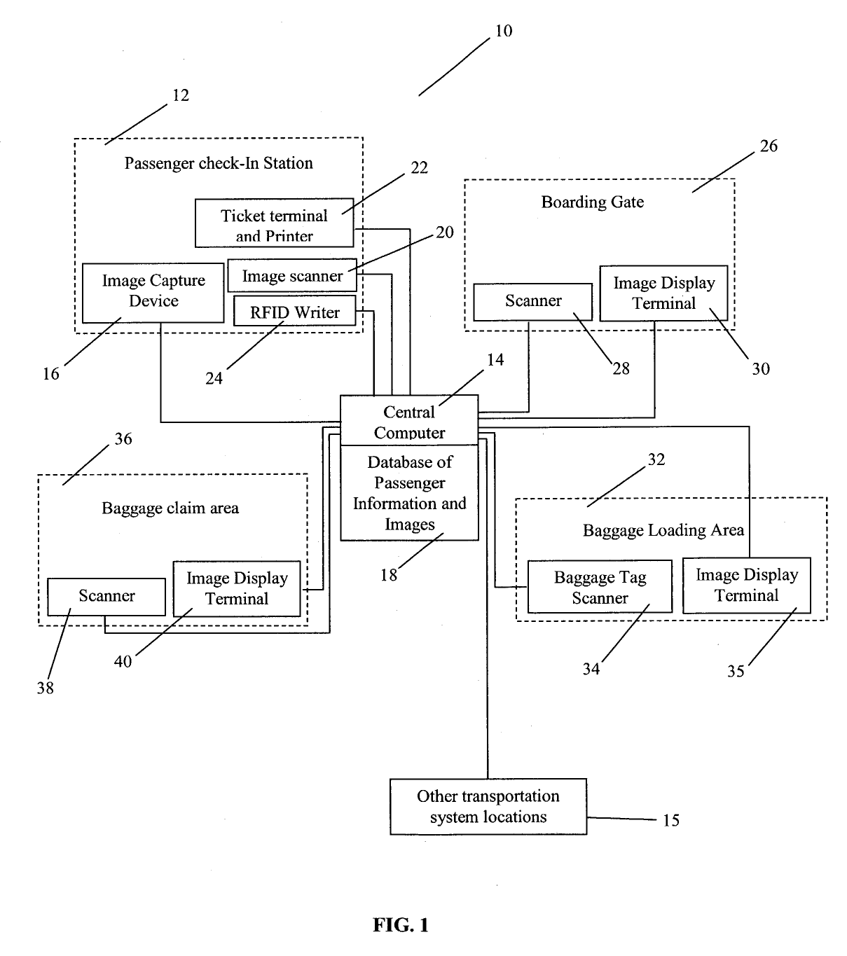

FIG. 1 shows a schematic diagram of a preferred embodiment of a passenger and baggage control system 10 made in accordance with the present invention. Passenger check-in station 12 is the point of entry for a ticketed passenger about to embark on a transportation service, for example, an airline, railroad line, cruise or passenger ship, bus service, or the like. The check-in station 12 is where passengers present tickets and personal identification documents, and check any baggage they may have. Check-in station 12 includes a number of devices all connected to a central computer 14. Central computer 14 serves as a coordination and communications device for all system components in baggage control system 10 and has associated with it a database 18 where passenger reservation and trip schedule information are stored. Baggage control system 10 is also linked via a communications channel via central computer 14 to other transportation system locations 15. By linking baggage control system 10, which is located at a particular departure location, with other departure and arrival locations in the transportation system, passenger and trip information may be shared between these other locations.

Digital image capture device 16, provided to capture an image of a passenger checking into the transportation service, comprises a digital camera conveniently mounted at check-in station 12. Images captured of passengers by capture device 16 are uploaded to central computer 14 and stored in database 18 in association with a passenger's reservation information. An image scanner 20 is provided at check-in station 12 as an alternative means to acquire a passenger's image, for example by scanning a picture present on an identification document of a passenger such as a driver's license, passport, or other acceptable form of picture identification (ID). Image scanners useful for the practice of the invention include, but are not limited to, flat-bed or feed-through linear array scanners, or area-array scanners. Images of passengers scanned from identification documents are transmitted to central computer 14 and stored in database 18, again in association with the passenger's other identification information. By passenger's other identification information is meant, by way of example but not limited to, a passenger's social security number, driver's license ID number, or other unique personal information known only to the passenger, or a passenger's distinguishing physical characteristics.

Printer 22 is used to print passenger tickets, boarding passes, baggage tags and claim checks, which have been compiled for printing by central computer 14 from the passenger information stored in database 18. Ticket terminal and printer 22 may contain any type of digital printer such as, for example, a laser printer, ink jet printer, or thermal transfer printer. A radio frequency identification (RFID) writer 24 is used to record trip and passenger information to the memory of RFID tags. These RFID tags may be incorporated in a baggage tag for automatic baggage tracking and baggage location, as discussed in greater detail later herein.

Boarding gate 26 in FIG. 1 is a control point in the baggage control system 10 where passengers must present a valid boarding pass in order to be admitted to board a transportation vehicle for departure. Scanner 28 is used to electronically scan machine readable information on boarding passes for the purpose of validation of the passes. If the passenger's image is not printed directly on the boarding pass, then image display terminal 30 can be used to retrieve and display passenger images from database 18 of passengers presenting a boarding pass. As described previously, other passenger-specific information such as social security number, driver's license ID, and the like, can also be accessed from database 18 and used for further verification of a passenger if needed. Scanner 28 and image display terminal 30 are both connected to central computer 14.

In baggage loading area 32, checked baggage is assembled for loading into the baggage hold of the transportation vehicle being prepared for departure. Baggage tag scanner 34, connected to central computer 14, is used to scan any machine-readable information present on baggage tags as they are loaded into the baggage hold of the transportation vehicle. The scanned baggage information is transmitted to central computer 14, and stored in database 18 in association with the particular trip being loaded for departure. A list of all baggage loaded for a particular trip can be compiled from this information. An image display terminal 35 is provided in order to signal information to the baggage loading area 32 from the central computer 14 during baggage loading.

Passengers debarking from a vehicle which has arrived at its destination claim any checked baggage at baggage claim area 36. Scanner 38 is used to scan machine-readable information on both baggage claim checks and baggage tags and the passenger's image may be retrieved via central computer 14 if it is not printed directly on the baggage tag. Central computer 14 is able to obtain passenger reservation information and passenger images from the passenger's original departure location through the transportation system's communication hub 15. Hub 15 is connected to all the transportation system's computers at the various departure and arrival locations via any of a number of well-known communications channels or networks (not shown). Image display terminal 40 may be used to display images of passengers desiring to claim baggage.

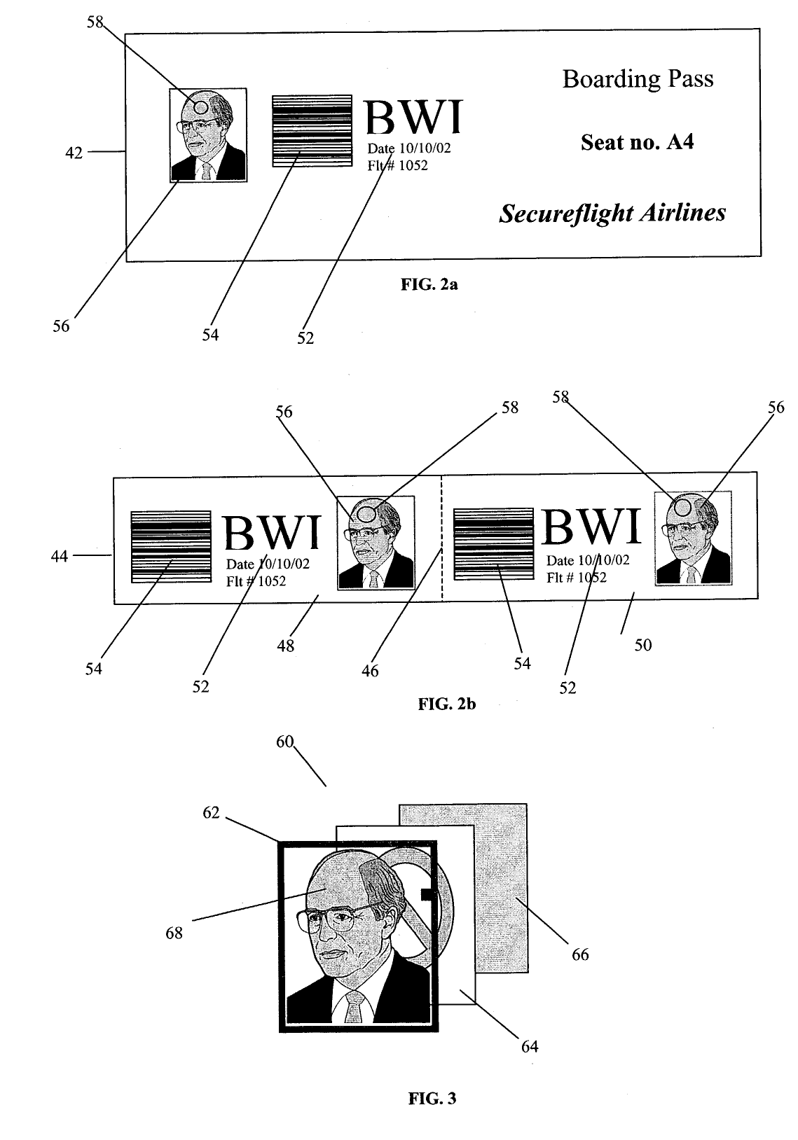

In FIG. 2a is shown a boarding pass 42 made in accordance with the present invention and useful in the passenger and baggage control system described in FIG. 1. Boarding pass 42 has information relating to a particular trip of the passenger, printed both as human-readable indicia 52 and machine-readable indicia 54. Also included on boarding pass 42 is an image 56 of the passenger for whom the baggage tag and claim check are issued. Image 56 may be printed directly on boarding pass 42 using printer 22 (FIG. 1), or printed separately as a “sticker” (described in more detail later) and then adhered to boarding pass 42 which may have been printed previously.

In FIG. 2a is also indicated a location 58 where a visually indiscernible authentication mark is provided that is incorporated by one of a number of data hiding techniques. Such an indiscernible authentication mark may be read only by an appropriately equipped scanner and is useful to prevent counterfeiting of boarding passes and baggage tags, since the mark is not easily copied by conventional copying means. A particularly useful means of inserting such an indiscernible authentication mark is by the technique of data hiding known as steganography, or digital watermarking. In digital watermarking, information is hidden invisibly in a digital image, such as in the image of a passenger 56. A technique particularly useful for hiding data in an image in this way is disclosed in commonly assigned U.S. Pat. No. 5,859,920 to Daly, et al., and the method of Daly et al. is hereby incorporated in its entirety by reference.

Other means of incorporating a visually indiscernible authentication mark on pass 42 may also be used, for example by the well known methods of overprinting indicia using inks visible only under ultraviolet or infrared illumination. Yet another means of incorporating authenticating information on pass 42 is disclosed in the commonly assigned U.S. Pat. No. 6,094,279 to Soscia. The Soscia patent teaches a method of invisibly incorporating data by overprinting with an infrared light absorbing ink. The Soscia method is hereby incorporated in its entirety by reference.

In FIG. 2b is shown a two-part combined baggage tag-claim check document 44. When a bag is checked, document 44 is printed and then separated along perforation line 46 into a baggage tag part 48 that is to be attached to a piece of baggage being checked by the passenger, and a claim check part 50 that is to be given to the passenger. Both baggage tag part 48 and claim check part 50 have printed thereon human readable indicia 52 relating to passenger trip information and machine readable indicia 54 also carrying the same trip information. Both baggage tag part 48 and claim check part 50 also have printed thereon passenger image 56 with indiscernible authentication mark 58. Indicia 52, 54 and image 56 are identical to those printed on boarding pass 42 as described previously for FIG. 2a. It will also be appreciated that, within the scope of the invention, the documents 48 and 50 may be printed separately to begin with rather than as a two-part document as shown in FIG. 2b.

While image 56 of a passenger is shown printed in visible form on the documents 42 and 44, it will be understood that also within the scope of the invention, passenger image information may also be incorporated on documents 42 and 44 by other means. For example, passenger image data may be compressed and encoded, and the encoded compressed image data printed on the documents 42 and 44. A method of highly compressing and encoding image data for a human face is disclosed in the commonly assigned U.S. Pat. No. 5,466,918 to Ray, et al. In Ray et al. it is taught that images compressed by the method disclosed may be included on documents 42 and 44 in a magnetic stripe, similar to the stripe found on transaction cards. In a related disclosure in U.S. Pat. No. 5,673,320, also to Ray, et al., it is disclosed how a highly compressed facial image may be encoded in a printed code such as a 2-dimensional bar code. Both Ray methods are hereby incorporated by reference.

Still another means of incorporating passenger image information on the documents 42 and 44 comprises including on the documents an encoded storage location, such as a computer address location in the database 18, where the actual image data file is stored. In practice, the encoded storage location is scanned by scanner 28 at the boarding gate 26, decoded by central computer 14, and the image data retrieved from the database 18 and displayed on the display terminal 30.

As mentioned previously, a radio frequency ID (RFID) tag is a device particularly well known in the art and useful for tracking individual items, for example in a manufacturing system, or for parts inventory control. RFID tags are inexpensive, thin electronic devices, easily attachable to an object, and require no power source of their own to operate. An RFID tag operates as a transponder and returns stored information when interrogated by an RF transceiver tuned to the appropriate frequency.

In FIG. 3 is disclosed one method of incorporating an RFID tag in a baggage tag. FIG. 3 shows an exploded view of an image sticker 60 with image receiving layer 62, RFID tag transponder layer 64, and adhesive backing layer 66. In separate steps, the sticker has image 68 printed on it using digital printer 22 and the bag-specific passenger and trip information recorded on the RFID layer using RFID writer 24. The completed sticker 60 is then applied to a baggage tag. An RFID tagged bag may be easily located at a later time using a transceiver as described later herein in more detail. It will also be recognized that, within in the scope of the invention, other means of incorporating an RFID tag on a baggage tag may be used, such as attaching it at a location on the tag different from the location of the image.

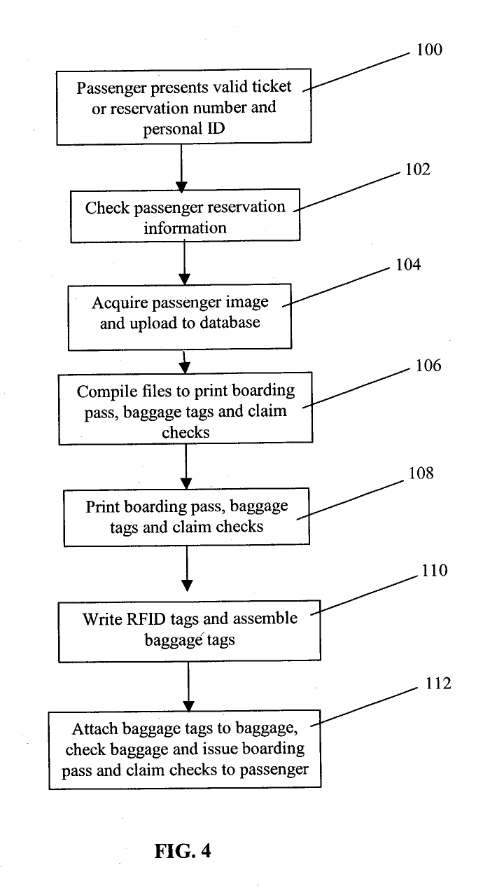

In order to more clearly understand the present invention, a detailed description of its operation will now be discussed. Turning to FIG. 4, there is shown a flow diagram of the steps which are carried out at the passenger check-in station 12. When a passenger arrives at check-in station 12, he or she presents a valid ticket or reservation number and some form of identification (step 100). The passenger's reservation information is checked by the ticket agent in step 102 by comparing it to the information stored in database 18 using ticket terminal 22.

Next, in step 104, a digital image of the passenger is acquired, either by using the image capture device 16, or by scanning the passenger's picture-bearing identification document such as a driver's license or passport using scanner 20. The passenger's captured digital image is then uploaded in step 104 to the database 18.

All data files needed to print the passenger's boarding pass, baggage tags and baggage claims are compiled in step 106 by central computer 14 from information stored in database 18. Files included in the compilation comprise the passenger's trip information (example, flight number, bus number, etc), date of travel, destination, and the passenger's image. As part of the compilation, a digital watermark is inserted in the image data file of the passenger's image, as described previously. The digital watermark may, for example, contain the passenger's trip information, or a portion thereof, or may simply be a mark which indicates the authenticity of the boarding pass or baggage tag. As an alternative to a digital watermark described previously, a file may be compiled to be printed on the documents 42 and 44 using an ink which is invisible in visible light, but which fluoresces when illuminated by ultraviolet or infrared light, or absorbs infrared light. As discussed previously, the passenger's digital image is compiled to be printed either as a pictorial representation, or is compressed and encoded to be printed as data only, or a pointer to the location of the picture in database 18 is printed.

The passenger's boarding pass, baggage tags and baggage claim check are then printed using printer 22 in step 108 with the information compiled, including both human and machine readable forms (example, bar code), as shown earlier in FIGS. 2a and 2b.

An RFID tag is prepared for each bag checked in step 110 using RFID writer 24 to record on the tag the same trip information, or a subset thereof, as that printed on the corresponding baggage tag. Alternatively, a pointer to the location of the passenger's data in database 18 may be recorded in the RFID's memory.

The baggage tags are then assembled in step 110 as described previously and, in step 112, the baggage tags are attached to the passenger's bags. The passenger's bags are checked, and the passenger is issued a baggage claim check and a boarding pass (step 112). The passenger is now ready to proceed to the boarding gate.

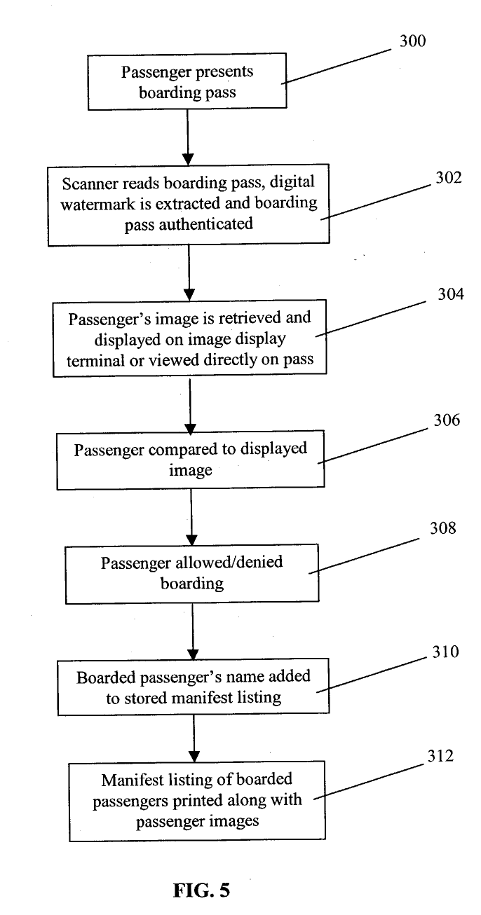

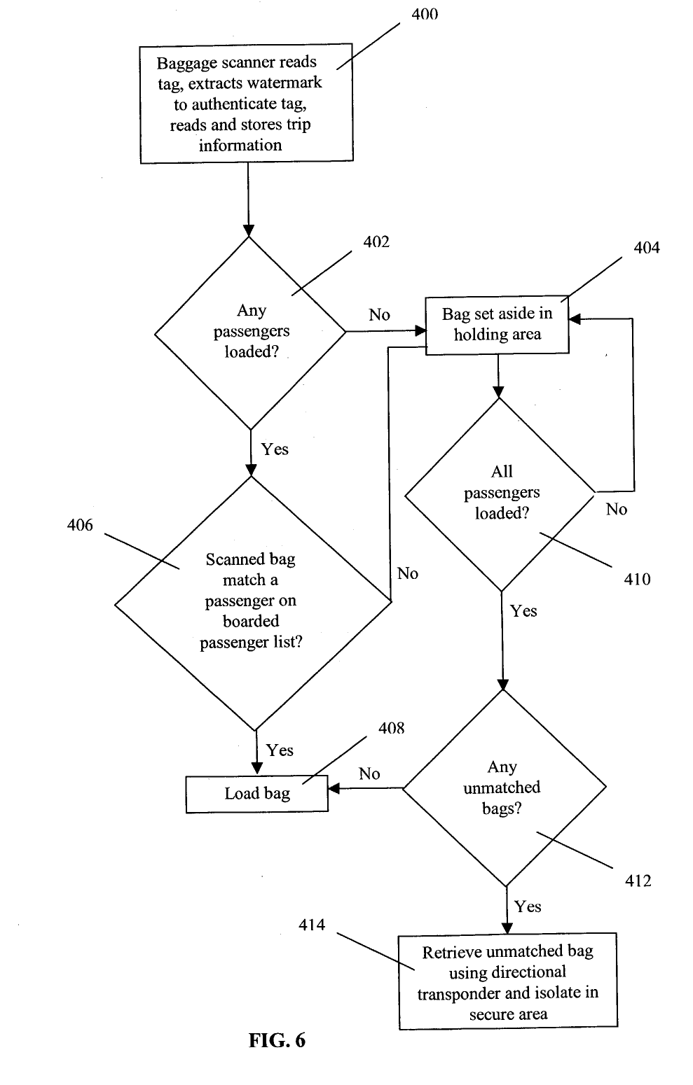

The steps carried out at the boarding gate 26 are described in detail in FIG. 5. Arriving at the boarding gate 26 in step 300, the passenger presents his or her boarding pass and the boarding pass is read by scanner 28 in step 302. The information scanned from the boarding pass is passed to central computer 14 where the digital watermark, if present in the image data, is extracted and the boarding pass authenticated (step 302). Other means of authentication of the boarding pass may also be used at this point in the process. For example, if an authentication mark printed in an ultraviolet fluorescing ink is present, the boarding pass can be examined for the presence of such a mark, using an ultraviolet light source to examine the pass.

In step 304, the passenger's image is viewed directly on the boarding pass, and is retrieved and displayed on image display terminal 30. The passenger's actual appearance is compared directly to passenger's image in block 306 by a boarding gate operator. Alternatively, as discussed previously, the passenger's image may also be reconstructed from compressed, encoded data printed on the pass, or retrieved from database 18, and displayed on image display terminal 30 for comparison to the passenger. If the actual passenger passes the comparison to the image of the passenger, then the passenger is admitted to board in step 308.

The boarded passenger's name is added to a list of boarded passengers (step 310) for the particular trip compiled and stored in database 18. Once all passengers are boarded, a manifest of boarded passengers is printed in step 312, and this list can include an image of each passenger printed in reduced size directly on the manifest. Such a pictorially enhanced passenger manifest can be used later to quickly check or re-check which passenger's have actually boarded and are occupying the vehicle.

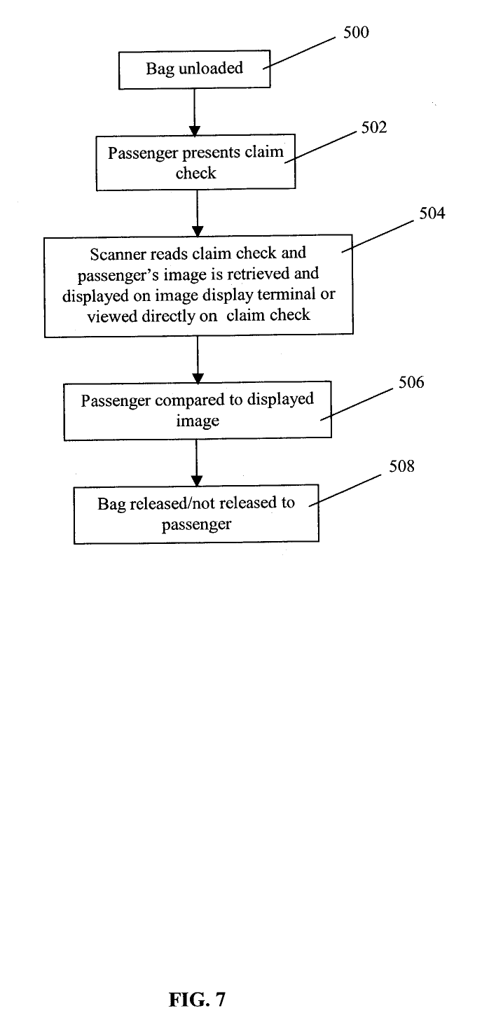

Turning now to FIG. 6, the steps carried out in the practice of the invention in the baggage loading area 32 are detailed. First, in step 400, the baggage tags of bags about to be loaded into the baggage hold of the transportation vehicle (example, airplane, train, bus, etc) are scanned by baggage tag scanner 34. Also included in step 400, in a manner analogous to that described previously for the authentication of boarding passes, information scanned from the baggage tag is passed to central computer 14 where the digital watermark, if present in the image data, is extracted and the baggage tag authenticated. Passenger and trip information is also scanned and the bag is flagged in database 18 as having been authenticated.

Next, in step 402, database 18 is consulted for the particular trip in question to determine if any passengers have been boarded. If no passengers have been loaded (sometimes baggage loading may begin well before passenger boarding) the bag is set aside in a secure holding area in step 404. This holding area may be outside the transportation vehicle, within the transportation vehicle, or in a special container as provided by the transportation service.

In step 406, the database is consulted to determine if the bag just scanned belongs to a boarded passenger. If it does, a go-ahead signal is sent to the image display terminal 35 in the baggage loading area 32, and the bag is loaded into the baggage hold of the vehicle in step 408. If not, the bag is set aside in the holding area as before in step 404.

Unloaded bags remain in the holding area until all passengers have been loaded (steps 410 and 404). When all passengers have been loaded, then a check is run in step 412 by central computer 14 using the data in database 18 to determine if any bags in the holding area have no matching boarded passengers. If there are no bags not matched to boarded passengers, then another go-ahead signal is sent to terminal 30 and the bags from the holding area are all loaded (step 408). If the holding area is in the transportation vehicle, the cargo door is then closed. If the holding area is a container, then the container is loaded. If, in the comparison run in step 412, it is determined that one or more bags is unmatched, then it becomes necessary to very quickly find this bag or bags in the holding area and isolate them, particularly if the holding area is inside the vehicle.

In step 414, the RFID tags integrated with the baggage tags (see FIG. 3 and accompanying description) provide a means for quickly locating an unmatched bag so that it may be isolated. A directional transponder tuned to the frequency of the baggage tags RFIDs is particularly useful in locating a particular RFID tag in an area where there may be many others. An example of such a locating system is disclosed in published PCT Patent Application WO 01/94974, to Carrender, where it is disclosed how the location of an RFID tag may be determined in space, based on phase differences between signals transmitted to the RFID. The method of Carrender transmits from an interrogator to an RFID, a first and second signal at first and second frequencies, respectively. The phase of the second signal is compared with that of the first signal and a distance between the interrogator and RFID is determined based on the phase difference between the first and second signals. The Carrender method is herein incorporated by reference. Once an unmatched bag has been located, it can be quickly removed in step 414 to an isolated secure area for further investigation.

Finally, when a trip is completed, a passenger may claim any checked bags at baggage claim area 36, located at the destination of the trip. FIG. 7 provides a flow chart of the steps to be carried out in the practice of the invention at the baggage claim area. Baggage is unloaded in step 500 in the baggage claim area 36 and the passenger presents a claim check to claim his baggage in step 502. Scanner 38 is used to scan the claim check, and in a manner completely analogous to the process described for boarding (see FIG. 4), the claim check is authenticated in step 504. The passenger's image is compared to the passenger in step 506. Passengers having valid claim checks who match their images have their bags released to them in step 508.

The invention has been described in detail with particular reference to certain preferred embodiments thereof, but it will be understood that variations and modifications can be effected within the scope of the invention.

### Parts List

10 Baggage control system

12 Check-in station

14 Central computer

15 Transportation system locations

16 Image capture device

18 Database

20 Image scanner

22 Printer

24 RFID writer

26 Boarding gate

28 Scanner

30 Image display terminal

32 Baggage loading area

34 Baggage tag scanner

35 Image display terminal

36 Baggage claim area

38 Scanner

40 Image display terminal

42 Boarding pass

44 Baggage tag-claim check

46 Perforation line

58 Baggage tag part

50 claim check part

52 Human readable indicia

54 Machine readable indicia

56 Passenger image

58 Authentication mark

60 Image sticker

62 Image receiving layer

64 RFID transponder layer

66 Adhesive backing layer

68 Sticker image

100 Step

102 Step

104 Step

106 Step

108 Step

110 Step

112 Step

300 Step

302 Step

304 Step

306 Step

308 Step

310 Step

312 Step

400 Step

402 Step

404 Step

406 Step

408 Step

410 Step

412 Step

414 Step

500 Step

502 Step

504 Step

506 Step

508 Step

What is claimed is:

1. A method for passenger and baggage security control in a transportation system, comprising the steps of:
acquiring a digital image of a passenger;
providing a passenger boarding pass, a baggage tag, and a baggage claim check, each said item bearing machine and human readable trip information, image information related to said passenger's digital image, and hidden authenticating information, said baggage tag also having an RFID device bearing said trip information;
electronically scanning said machine readable information on said baggage tag when said baggage is loaded for said trip and creating and storing a list of all loaded baggage for said trip;
authenticating said boarding pass by electronic scanning to detect said hidden authentication information when said boarding pass is presented;
accessing said passenger digital image information and comparing said passenger's appearance to said image of said passenger;
accepting said passenger for boarding when said authentication data is present and said passenger's appearance matches said passenger image; and
creating and storing a list of all boarded passengers.

2. The method of claim 1 further comprising the step of:
comparing said list of boarded passengers with said list of loaded baggage to identify any baggage loaded, but not matched to a corresponding boarded passenger.

3. The method of claim 2 further comprising the step of locating any said unmatched loaded baggage by locating said RFID device on said baggage using a directional RFID reader.

4. The method of claim 1 further comprising the steps of:
authenticating said baggage claim check by electronic scanning to detect said hidden authentication information when said claim check is presented by said passenger, and comparing said passenger's appearance to said image of said passenger; and
releasing said baggage to said passenger when said authentication data is present and said passenger's appearance matches said passenger picture.

5. The method of claim 1 wherein said step of acquiring an image of a passenger further comprises capturing and storing a digital image of said passenger during passenger check-in.

6. The method of claim 1 wherein said step of acquiring an image of said passenger further comprises scanning said image from said passenger's picture ID.

7. The method of claim 1 wherein said step of acquiring an image of said passenger further comprises retrieving said image from a secure database of images.

8. The method of claim 1 wherein said information related to said passenger digital image further comprises a printed image of said passenger.

9. The method of claim 1 wherein said information related to said passenger digital image is a data-compressed version of said digital image.

10. The method of claim 1 wherein said information related to said passenger digital image is a pointer to a database of passenger digital images.

11. The method of claim 1 wherein said machine readable information further comprises information encoded in a bar code.

12. The method of claim 1 wherein said machine readable information further comprises information encoded in a magnetic stripe.

13. The method of claim 1 wherein said hidden authentication information further comprises a digital watermark embedded in said image of said passenger.

14. The method of claim 1 wherein said hidden authentication information further comprises human or machine readable information printed in an ultraviolet or infrared fluorescing ink.

15. The method of claim 1 wherein said hidden authentication information further comprises human or machine readable information printed in an infrared absorbing ink.

16. The method of claim 1 wherein said step of creating and storing a list of all boarded passengers further comprises the step of printing a list of all boarded passengers, said list also having said acquired image of each said passenger printed thereon.

17. A label system for passenger and baggage control in a transportation system, comprising:
a boarding pass part;
a baggage tag part and baggage claim check part for each piece of said baggage of said passenger;
information related to a digital image of said passenger incorporated on each said parts of said label;
human and machine readable trip information included on each said parts of said label;
hidden authenticating information incorporated in each said parts of said label; and
said baggage tag part also having an RFID device bearing at least a portion of said trip information.

18. The label system of claim 15 wherein each said baggage tag and baggage claim check parts are combined in a unit when printed, said baggage tag and claim check parts able to be detached after printing.

19. The label system according to claim 15 wherein said machine readable information is incorporated in a bar code.

20. The label system according to claim 15 wherein said machine readable information is incorporated in a magnetic strip.

21. The label system according to claim 15 wherein said hidden authenticating information further comprises a digital watermark embedded in said image of said passenger.

22. The label system according to claim 15 wherein said hidden authenticating information further comprises human or machine readable information printed in an ultraviolet or infrared fluorescing ink.

23. The label system according to claim 15 wherein said hidden authenticating information further comprises human or machine readable information printed in an infrared absorbing ink.

24. The label system according to claim 15 wherein said information related to a digital image of said passenger further comprises a printed image of said passenger.

25. The label system according to claim 15 wherein said information related to a digital image of said passenger further comprises a data-compressed version of said digital image.

26. The label system according to claim 12 wherein said image is incorporated as a sticker print on each part of said label system.

27. The label according to claim 9 wherein said sticker print further comprises a read/write RFID device.
